(19) United States
(12) Patent Application Publication
(10) Pub. No.: US 2003/0059503 A1
(43) Pub. Date: Mar. 27, 2003

(54) Method and apparatus for preparing ice-creams and packaged semi-finished product used therefor

(76) Inventor: Vittorio Rabboni, Ventoso di Scandiano (IT)

Correspondence Address: WILLIAM COLLARD, COLLARD & ROE, P.C., 1077 NORTHERN BOULEVARD, ROSLYN, NY, 11576, US

(21) Appl. No.: 10/258,383

(22) PCT Filed: Apr. 24, 2001
(86) PCT No.: PCT/EP01/04614

(30) Foreign Application Priority Data
Apr. 26, 2000 (IT) M02000AQ000087

(51) Int. Cl. C12C 1/027

(52) U.S. Cl. 426/106

(57) ABSTRACT

Disclosed are non-dairy dessert compositions which are free of conventional emulsifiers and which are heat shock stable. The compositions comprise from about 50% to 98% of a specially prepared comestible base, from about 0.4% to 4% of an acid-stable whipping agent, from about 0.05% to 0.5% of an acid stable polysaccharide gum and from about 1% to 15% of an edible fatty triglyceride oil. The moisture content of the dessert compositions ranges between 48% and 65%. The comestible base is prepared by forming an uncooked blend comprising from about 25% to 65% by weight of the blend of citrus juice vesicles, from about 7% to 45% of a nutritive carbohydrate sweetening agent, from about 1% to 5% of an ungelatinized starch, from about 0.1% to 0.4% of water-soluble pectin, from about 8% to 60% by weight of water and sufficient non-volatile edible organic acid to provide the blend with a pH between 2.5 and 5.5. The blend is then cooked to a viscosity (190° F.) between 7,000 and 10,000 cp. and a moisture content between 30% to 60%. An aerated frozen dessert is prepared by aerating the mixture of these ingredients to a density of 0.2 to 0.95 g./cc. and then statically freezing the aerated mixture.

The invention relates to extemporaneous manufacturing of ice-creams, a laboratory for producing ice-creams and selling them to the public and a set of packages of semi-finished product for preparing ice-creams.

Prior art comprises a method for preparing milk-based ice-cream, wherein milk, sugar, eggs—if any—, cream, emulsifiers, stabilizers and milk proteins (these last three ingredients can be also put together into a commercial powdery base) are mixed together in order to obtain a liquid mixture that is pasteurized and frozen. The frozen mixture is then weighed and a pre-established amount of flavouring paste is blent to it. The flavouring paste has to be drawn from a container having a releatively high capacity and weighed according to the recipe, after mixing from the bottom in order to have uniformity of flavoux.

For preparing fruit-based ice-cream, water, sugar, emulsifiers, stabilizers—or a commercially available powdery base already containing emulsifiers and stabilizers—are mixed together.

A pre-determined amount of such powdery base has also to be previosly drawn from a container having a relatively high capacity and then weighed and mixed together with sugar and water in order to obtain a liquid mixture to which, after further weighing, whipped fruit and subsequently a fruited flavouring and acidifying paste are added.

Also the fruited flavouring and acidifying paste has to be weighed according to the recipe to be prepared, after mixing from the bottom in order to uniform the flavour.

The pastes described above consist of semi-finished products prepared in food industry and are supplied to ice-cream makers in rather large initially aseptic packages, each of about 5-10 Kg.

However, after a first opening, content of such package suffers from progressive contamination caused by bacterial agents of the environment and manipulations to which it is subjected during its life-time.

In Figures A and B, block diagrams concerning conventional preparing of respectively milk-based ice-cream and fruit-based ice-cream are shown.

In both cases, preparaing ice-cream according to the conventional methods described above requires qualified and trained manpower, as well as arrangement of a laboratory properly equipped and large enough to contain all ingredients and machinery, among which pasteurizer, aging device (i.e. a cooled container with a stirrer), freezers.

An object of the invention is to simplify preparing of ice-creams.

A further object of the invention is to simplify laboratories for prepararing ice-creams.

A further object is to allow also not experienced personnel to prepare ice-creams ready for sale and consumption by the public.

All that without impacting in a negative manner onto the quality of the finished product, but rather improving hygienic conditions of manufacturing.

In a first aspect of the invention, there is provided a set of semi-finished industrial products for preparing ice-cream to be offered to the public in suitable containers, said semi-finished products being packaged in packaging unit means, characterized in that said packaging unit means only comprises amounts of said semi-finished products which allow preparing the amount of ice-cream that can be contained in one or more of said containers (tubs).

In a second aspect of the invention, there is provided packaging units means of semi-finished industrial products for preparing ice-cream to be offered to the public in suitable containers, characterized in that, said packaging units means only comprises amounts of said semi-finished products which allow preparing the amount of ice-cream that can be contained in one or more of said containers (tubs).

In a third aspect of the invention, there is provided a method of preparing ice-cream, comprising mixing semi-finished products, contained in packaging unit means, with diluting fluid means in order to obtain a fluid mixture to be frozen, characterized in that, it further comprises pouring the whole content of said packaging unit means into container means for obtaining said mixture ready to be frozen.

Since the semi-finished products are packaged in disposable packs, that is packs discardable after a first use, the operator can use for a certain batch of ice cram to be sold the whole content of each package without leaving opened packs to be used again, that would be subjected to bacteriological contamination.

This allows to prevent the pasteurization because each package contains products arranged in a substantially aseptic way. Furthermore, the various ingredients, or the liquid mixture, have no longer to be weighted at the exit from the pasteurizer, because the amount of product contained in each package is measured in a suitable manner according to the amount of ice-cream to be prepared.

Prepararing of ice-cream is extremely simplified, so that also an unskilled operator, can easily prepare ice-cream of high quality.

Furthermore, the recipe is very simplified and therefore the presence of an expert chef is no longer required, which is always difficult to find and of great expense.

Furthermore, prepararing the ice-cream is much faster, which allows to reduce the number of persons in charge.

In a fourth aspect of the invention, there is provided apparatus for preparing ice-cream, comprising container means (pail) for mixing semi-finished industrial products for preparing ice-cream by which a fluid mixture can be obtained, and blender means for blending said fluid mixture to obtain ice-cream, and not comprising weighing means for weighing said mixture, nor pasteurizer means for pasteurizing said mixture nor aging means for aging said mixture.

Owning to this aspect of the invention, it is possible to carry out preparing of ice creams in very reduced spaces. This greatly simplifies the laboratories for preparing of ice-cream.

Since the pasteurizer and the aging means have been removed, it is possible to save energy and to install electric energy with reduced power.

The invention will be better understood and carried out with reference to the drawings attached, that illustrates some indicative and not restrictive embodiment examples thereof, wherein:

Figure A is a block diagram concerning preparing traditional milk-based ice-cream;

Figure B is a block diagram concerning preparing traditional fruit-based ice-cream;

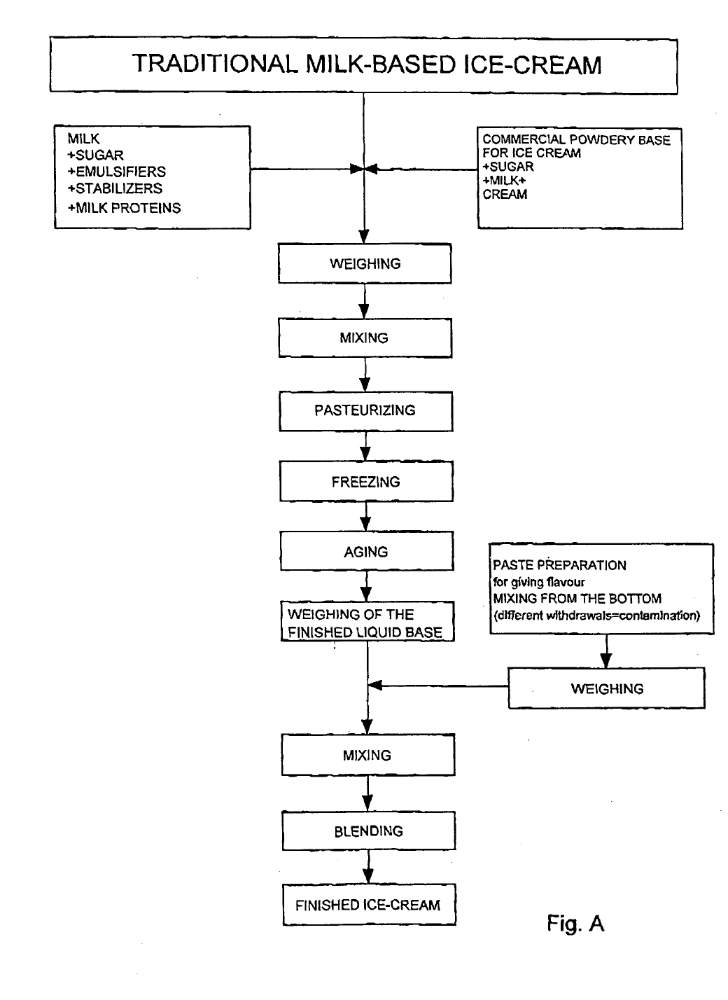

FIG. 1 shows schematically preparing milk-based ice-cream according to the invention;

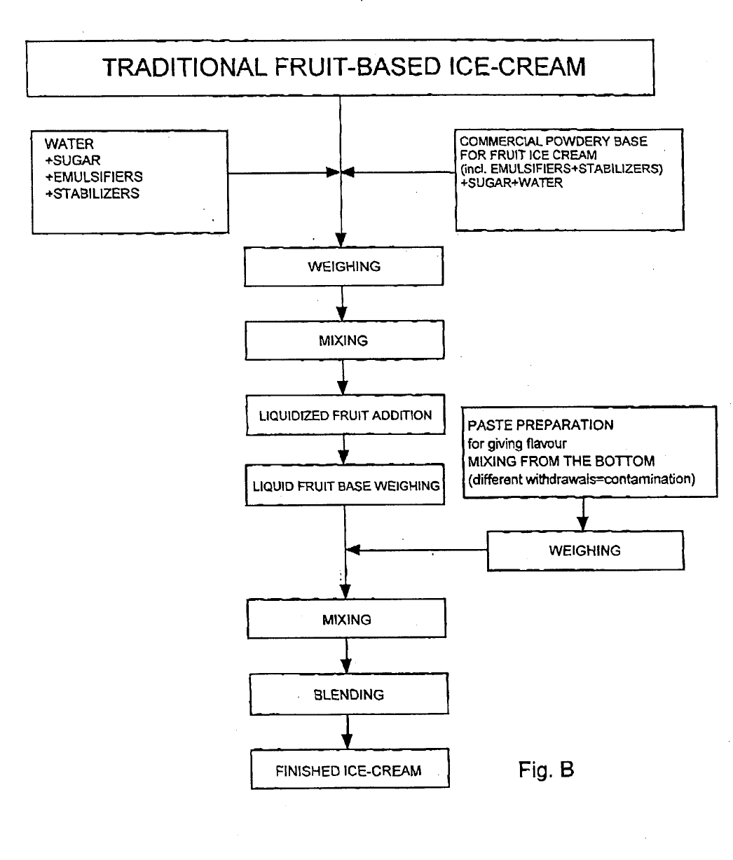

FIG. 2 is a view similar to FIG. 1, but relating to a variation;

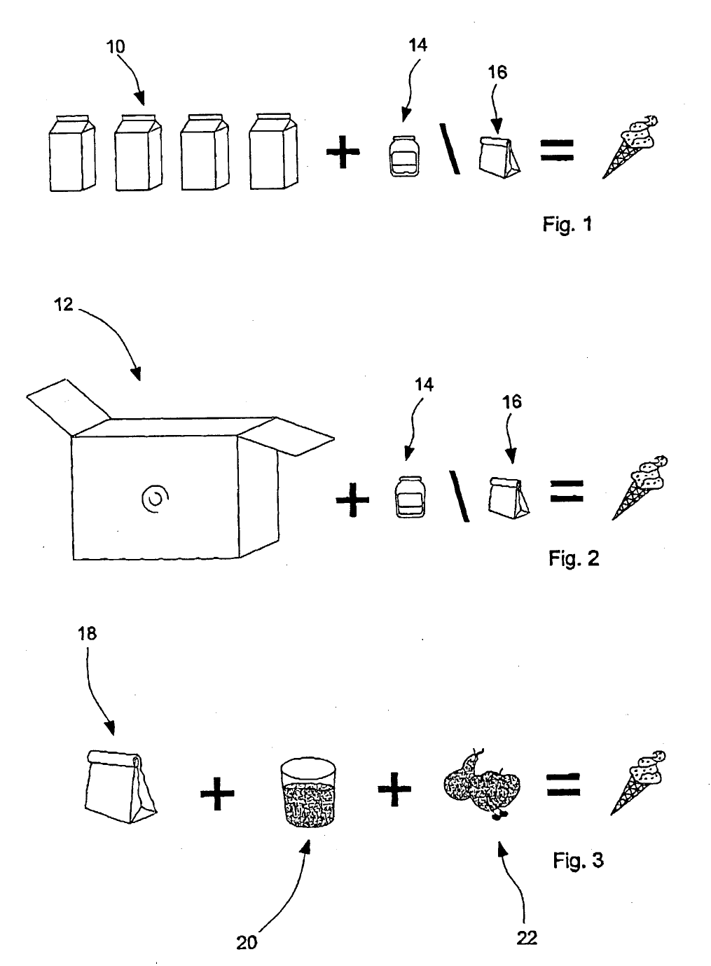

FIG. 3 is a view similar to FIG. 1, but relating to preparing of fruit-based ice-cream;

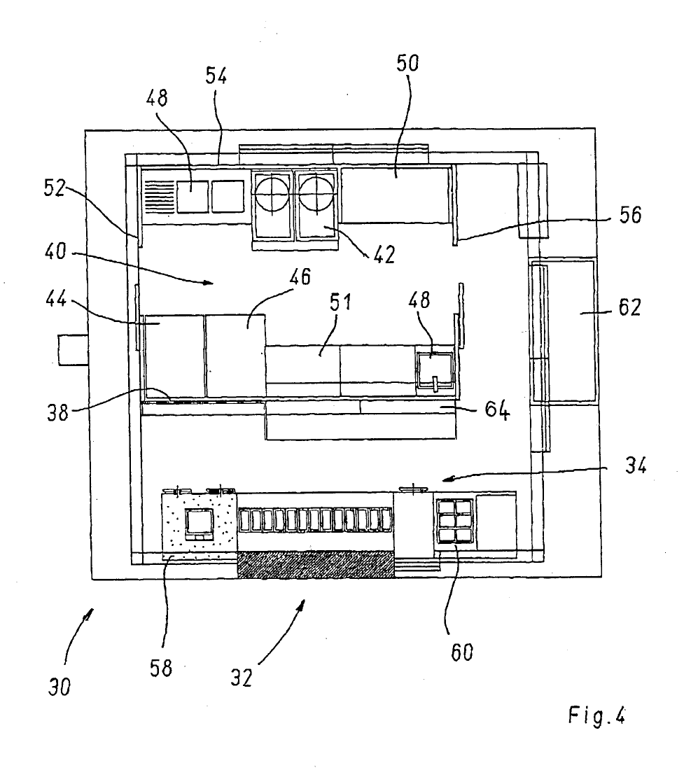

FIG. 4 is a schematic plane view of apparatus for preparing and selling ice-creams according to the invention.

As shown in FIGS. 1 and 2, first packaging units are provided having a parallelepiped shape 10, or bag-in-box 12, containing a base to be frozen for milk-based ice-cream, which are to be opened and fully mixed with the whole content of second packaging units having the form of jars 14, or bags 16 containing flavouring fluid paste.

Thereafter, the whole content of the firs; packaging units 10 and/or 12 is mixed with the whole content of the second packaging units 14 and/or 16 before introducing the mixture in a conventional blender from which the ice-cream is drawn, ready for exhibition and sale.

It is to be understood that, by changing the type of paste of the second packaging units 14 and/or 16, ice-creams of various flavours can be obtained.

With reference to FIG. 3, preparing a fruit-based ice-cream involves merely the addition to a further packaging unit 1E, containing a powder preparation, pre-dosed and balanced for preparing fruit-based ice-cream, containing emulsifiers, stabilizers, lyophilized fruit, food dyes—if any—, flavours, sugar, acidifiers, of water contained in a container 20 and possibly of pieces of fresh fruit 22, or whipped fruit, or fruit juice.

Also in this case, the amount of product in the further packaging unit 18 is fully used starting from a closed and sealed packaging.

As shown in FIG. 4, owning to the the invention, a kiosk 30 for preparing and the sale of ice-creams comprises a sale region 34, wherein a display stand 32 is arranged for the sale of cones or tubs of ice-cream, inside which the ice-cream containers are exhibited already prepared for sale. The sale region 34 is separated by a wall 38 from a working area 40 in which the required equipments for preparing ice-creams are contained, that is: a blender 42, a column freezer 44 for preserving fresh fruit, a deep freezer 46 for further freezing the ice-cream at the outlet of the creamer 42, one or more sinks 48, a working table 50 and cold stores 51 for preserving the fresh ingredients (fruit). The working area 40 is closed, as well as by the wall 38, by further walls 52, 54, 56.

The further walls 52, 54, 56 can be constituted by transparent material so as to allow the passer-by to observe how preparing of ice-creams takes place, This is allowed by the extreme hygienic quality of preparing process, performed with the use of the semi-finished products in the packages above described. Furthermore, it is observed that the whole complex of the equipments constituting the kiosk 30 can be partitioned into parts easy removable and transportable: a first part comprises the display stand 32 with possible cash desk 58 and sale counter 60, a second part comprises the intermediate wall 38 with back-counter 62 and shelves 64, at the sale side, and the column freezer 44, the deep freezer 46, the cold stores 51 and a sink 48, at the side of the working area 40, a third part comprising one of the walls 52, 54, 56 with a further sink 48, the creamer 42 and the working table 50.

In this way, it is possible to build the kiosk 30 in a very simple way and to install it in areas with a high traffic of public, both in closed environment and at the open air.

One or more freezer desks 63 are furthermore provided in order to exhibit the ice-cream in takeaway packages with different sizes from 500 g up to 2 Kg and furthermore in order to exhibit the ice-cream cakes also contained in insulating packages of polystyrene.

The kiosk 30 shows an engaging appearance because it can bring pictures of ice-cream that attract the public, it is very bright and coloured so as to give an impression of freshness and hygienic quality.

1. A set of semi-finished industrial products for preparing ice-cream to be offered to the public in suitable containers, said semi-finished products being packaged in packaging unit means (10, 12, 14, 16, 18), characterized in that, said packaging unit means (10, 12, 14, 16, 18) only comprises amounts of said semi-finished products for preparing the amount of ice-cream that can be contained in one or more of said containers.

2. Packaging unit means (10, 12, 14, 16, 18) of semi-finished industrial products for preparing ice-cream to be offered to the public in suitable containers, characterized in that, said packaging unit means (10, 12, 14, 16, 18) only contains amounts of said semi-finished products for preparing the amount of ice-cream that can be contained in one or more of said containers.

3. Method for preparing ice-cream, comprising mixing semi-finished products contained in packaging unit means (10, 12, 14, 16, 18) with diluting fluid means in order to obtain a fluid mixture to be frozen, characterized in that, it further comprises pouring the whole content of said packaging unit means into container means in order to obtain said mixture.

4. Method according to claim 3, wherein said diluting means is contained in further packaging unit means (10).

5. Apparatus for preparing ice-cream, comprising container means suitable for containing semi-finished industrial products for preparing of ice-cream to be mixed together for obtaining a fluid mixture, and blender means (42) for blending said fluid mixture and obtain ice-cream, and not comprising weighing means for weighing said mixture, nor pasteurizing means for pasteurizing said mixture.

6. Apparatus according to claim 5, whereon said blender means (42) and said container means are comprised into a preparation area (40).

7. Apparatus according to claim 6, wherein said preparation area further comprises freezer means (44) and cold stores (51).

8. Apparatus according to any one of claims 5 to 7 and further comprising a sale region (34).

9. Apparatus according to claim 8, wherein said sale region comprises a display stand (32).

10. Apparatus according to any one of claims 6 to 9, wherein said preparation area and said sale region comprises an intermediate wall (38) having the side facing the sale region comprising means for aiding the sale (64) and the side facing preparing area (40) comprising means for aiding preparing of ice-creams (44, 46, 51).

11. Apparatus according to any one of claims 6 to 10, and comprising a further wall (54) of said preparation area (40) to which further means for aiding preparing (48, 50, 52) is associated.
